(19) United States
(12) Patent Application Publication
(10) Pub. No.: US 2019/0039598 A1
(43) Pub. Date: Feb. 7, 2019

(54) VEHICLE CONTROL DEVICE

(71) Applicant: TOYOTA JIDOSHA KABUSHIKI KAISHA, Toyota-shi (JP)

(72) Inventor: Kenta KUMAZAKI, Anjo-shi (JP)

(73) Assignee: TOYOTA JIDOSHA KABUSHIKI KAISHA, Toyota-shi (JP)

(21) Appl. No.: 15/987,121

(22) Filed: May 23, 2018

(30) Foreign Application Priority Data
Aug. 1, 2017 (JP) 2017-149457

(51) Int. Cl. B60W 20/17; G05D 1/02; B60W 30/18; B60K 6/20

(52) U.S. Cl. CPC B60W 20/17; G05D 1/021; B60W 30/18127; B60Y 2300/18125; Y10S 903/903; B60Y 2200/92; B60K 6/20

(57) ABSTRACT

A control device is provided for a vehicle which includes an electric motor that executes regeneration during deceleration of the vehicle and which performs manned running with at least one occupant in the vehicle and also unmanned running without any occupant in the vehicle. The control device is configured to cause the electric motor to execute the regeneration within a regeneration allowable range, such that the regeneration allowable range for the unmanned running of the vehicle is larger than the regeneration allowable range for the manned running of the vehicle. The regeneration allowable range is defined by, for example, an allowable maximum regenerative torque that is variable depending on a running speed of the vehicle upon the regeneration by the electric motor.

This application claims priority from Japanese Patent Application No. 2017-149457 filed on Aug. 1, 2017, the disclosure of which is herein incorporated by reference in its entirety.

### FIELD OF THE INVENTION

The present invention relates to a control device for a vehicle that can be automatically driven either during manned running or unmanned running, wherein the control device is configured to execute regeneration by an electric motor during running of the vehicle.

### BACKGROUND OF THE INVENTION

There is known a technique in a vehicle capable of performing a manned running with an occupant or occupants being in the vehicle and unmanned running without any occupant being in the vehicle, wherein an output of a drive power source is controlled in a manner that varies depending on whether the manned running is being performed or the unmanned running is being performed. For example, JP-2016-102441A1 disclose a technique in a hybrid vehicle capable of performing the manned running and the unmanned running, wherein an output of an engine as the drive power source is more limited during the unmanned running than during the manned during, for reducing noise of the engine released outside the vehicle during the unmanned running.

### SUMMARY OF THE INVENTION

In a conventional vehicle control device configured to execute an energy regeneration, i.e., recover an energy upon braking of the vehicle, a regeneration allowable range is limited by taking account of drivability of the vehicle that relates to, for example, shock and noise generated inside the vehicle upon the regeneration. However, there is no study as to how the regeneration is to be controlled in automatic driving during unmanned running without any occupant in the vehicle. Thus, there is a possibility that a sufficient improvement of fuel economy has not been made with respect to regeneration during unmanned running by automatic driving.

The present invention was made in view of the background art described above. It is therefore an object of the present invention to restrain reduction of drivability that could be caused by regeneration executed during manned running and also to further improve fuel economy by studying the regeneration executed during the unmanned running by automatic driving.

The object indicated above is achieved according to the following modes of the present invention.

According to a first mode of the invention, there is provided a control device for a vehicle which includes an electric motor that executes regeneration during deceleration of the vehicle and which performs manned running with at least one occupant in the vehicle and also unmanned running without any occupant in the vehicle, wherein the control device is configured to cause the electric motor to execute the regeneration within a regeneration allowable range, such that the regeneration allowable range for the unmanned running of the vehicle is larger than the regeneration allowable range for the manned running of the vehicle. For example, the control device includes: an unmanned-running determining portion configured to determine whether the vehicle is in the unmanned running or not; and a regeneration-range setting portion configured to set the regeneration allowable range for the unmanned running when it is determined by the unmanned-running determining portion that the vehicle is in the unmanned running, and configured to set the regeneration allowable range for the manned running when it is determined by the unmanned-running determining portion that the vehicle is not in the unmanned running.

According to a second mode of the invention, in the vehicle control device according to the first mode of the invention, the control device is configured. When noise of the electric motor released outside the vehicle upon the regeneration meets a predetermined noise condition, to reduce the regeneration allowable range for the unmanned running, such that the regeneration allowable range for the unmanned running is reduced to be close to the regeneration allowable range for the manned running.

According to a third mode of the invention, in the vehicle control device according to the second mode of the invention, the predetermined noise condition includes running of the vehicle in at least one area and/or running of the vehicle in at least one time period, such that the control device determines that the noise of the electric motor released outside the vehicle upon the regeneration meets the predetermined noise condition, when the vehicle runs in the above-described at least one area and/or when the vehicle runs in the above-described at least one time period. The at least one area and the at least one time period are determined, for example, based on a history of complaints against the noise.

According to a fourth mode of the invention, in the vehicle control device according to any one of the first through third modes of the invention, the control device is configured to cause the electric motor to execute the regeneration within the regeneration allowable range that is defined by an allowable maximum regenerative torque that is variable depending on a running speed of the vehicle upon the regeneration by the electric motor. The allowable maximum regenerative torque is increased with increase of the running speed when the running speed is smaller than a given value, for example. The allowable maximum regenerative torque is reduced with increase of the running speed when the running speed is larger than a second value that is larger than the given value as a first value, for example. Further, the regeneration allowable range for the unmanned running is larger than the regeneration allowable range for the manned running, for example, such that that the allowable maximum regenerative torque at a certain value of the running speed during the unmanned running is larger than the allowable maximum regenerative torque at the certain value of the running speed during the maimed running, wherein the certain value is smaller than the given value.

According to the first mode of the invention, the control device is for a vehicle which includes an electric motor that executes regeneration during deceleration of the vehicle and which performs manned running with at least one occupant in the vehicle and also unmanned running without any occupant in the vehicle, wherein the control device is configured to cause the electric motor to execute the regeneration within a regeneration allowable range, such that the regeneration allowable range for the unmanned running of the vehicle is larger than the regeneration allowable range for the manned running of the vehicle. Therefore, the fuel economy during the unmanned running can be improved as compared with that during the manned running. In other words, the control device according to the invention makes it possible to improve the fuel economy during the unmanned running, as compared with a conventional control device.

According to the second mode of the invention, the control device is configured, when noise of the electric motor released outside the vehicle upon the regeneration meets a predetermined noise condition, to reduce the regeneration allowable range for the unmanned running, such that the regeneration allowable range for the unmanned running is reduced to be close to the regeneration allowable range for the manned running. This arrangement makes it possible to improve the fuel economy by the regeneration during the unmanned running, and also to restrain the noise generated by the electric motor upon the regeneration, from being released outside the vehicle during the unmanned running, when the noise meets the predetermined noise condition, namely, when there is a high need to restrain the noise.

According to the third mode of the invention, the predetermined noise condition includes running of the vehicle in at least one area (such as residential area) and/or running of the vehicle in at least one time period (such as nighttime), such that the control device determines that the noise of the electric motor released outside the vehicle upon the regeneration meets the predetermined noise condition, when the vehicle runs in the at least one area and/or when the vehicle runs in the at least one time period. This arrangement makes it possible to improve the fuel economy by the regeneration during the unmanned running, and also to more effectively restrain the noise generated by the electric motor upon the regeneration, from being released outside the vehicle during the unmanned running, by restraining the noise when the noise meets the predetermined noise condition which appropriately defines a situation or situations where there is a high need to restrain the noise.

According to the fourth mode of the invention, the control device is configured to cause the electric motor to execute the regeneration within the regeneration allowable range that is defined by an allowable maximum regenerative torque that is variable depending on a running speed of the vehicle upon the regeneration by the electric motor. This arrangement makes it possible to improve the fuel economy by the regeneration during the unmanned running, and also to suitably restrain deterioration of components involved in execution of the regeneration.

### BRIEF DESCRIPTION OF THE DRAWINGS

FIG. 1 is a view schematically showing constructions of parts of a hybrid vehicle in which a control device according to the present invention is provided, and explaining major functional portions of the control device which are provided for controlling the parts that relate to running of the vehicle;

FIG. 2 is a view schematically showing construction of a power transmission device of the hybrid vehicle in which the control device according to the invention is provided;

FIG. 3 is a table indicating a relationship between gear positions of a transmission (that is included in the power transmission device of FIG. 2) and combinations of coupling devices that are placed in engaged states to establish the respective gear positions;

FIG. 4 is a collinear chart indicating a relationship among rotational speeds of rotary modules of a transmission including an electrically controlled continuously variable transmission and an automatic transmission;

FIG. 5 is a view showing, by way of examples, a shifting map used for controlling gear shifting in the automatic transmission, a drive-power-source switching map used for switching between an engine running and a motor running, and a relationship between the shifting map and the drive-power-source switching map;

FIG. 6 is a view showing various signals inputted or outputted to or from an electronic control device that is provided as the control device in the vehicle of FIG. 1;

FIG. 7 is a view showing, by way of examples, a regeneration allowable range in which regeneration is allowable, wherein an upper limit of the range is defined by an allowable maximum regenerative torque that is variable depending on a running speed of the vehicle;

FIG. 8 is a flow chart showing a control routine executed for widening the regeneration allowable range during unmanned running by automatic driving;

FIG. 9 is a flow chart showing a control routine executed for widening the regeneration allowable range during unmanned running by automatic driving, except when a vehicle exterior noise is problematic;

FIG. 10 is a view schematically showing constructions of a power transmission device of another hybrid vehicle in which the control device according to the present invention is provided; and

FIG. 11 is a table indicating a relationship between gear positions of a transmission (that is included in the power transmission device of FIG. 10) and combinations of coupling devices that are placed in engaged states to establish the respective gear positions.

### DETAILED DESCRIPTION OF PREFERRED EMBODIMENTS

Hereinafter, some embodiments of the invention will be described in detail with reference to the accompanying drawings. The figures of the drawings are simplified or deformed as needed, and each portion is not necessarily precisely depicted in terms of dimension ratio, shape, etc.

### First Embodiment

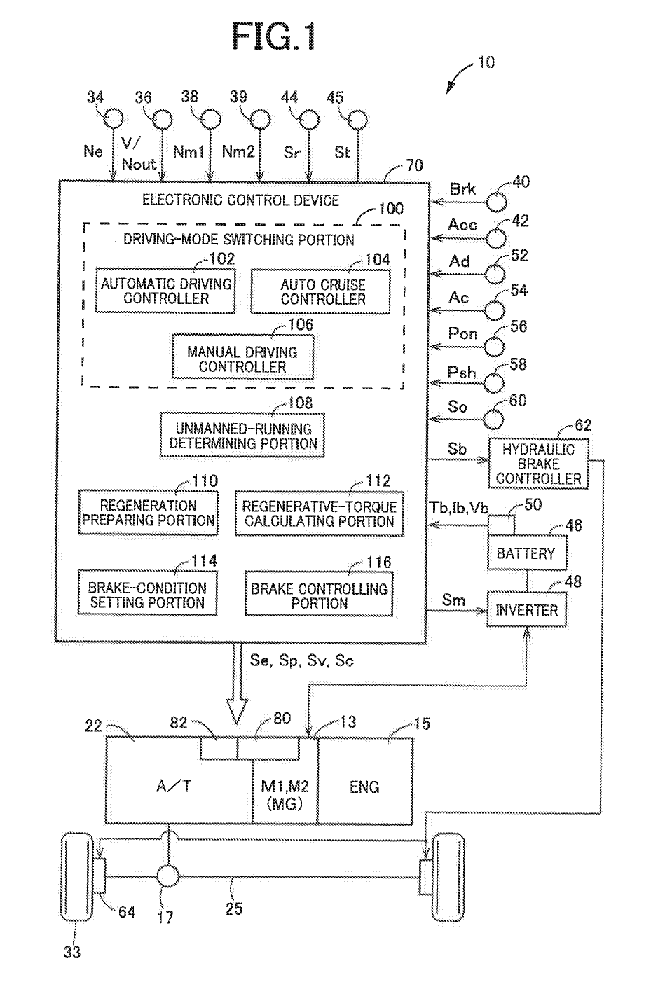

FIG. 1 is a view schematically showing a construction of a hybrid vehicle 10 to which the invention is applied. In the vehicle 10, a drive force, which is outputted from a differential portion 13 including drive power sources in the form of an engine 15 and first and second electric motors M1, M2, is inputted to an automatic transmission portion 22 functioning as an automatic transmission, and then transmitted to right and left drive wheels 33 via a differential gear device 17 and axles 25. The differential gear device 17 includes a gear meshing with an output gear (not shown) of the automatic transmission portion 22. Each of the first and second electric motors M1, M2 is driven by an electric power supplied from a battery 46 via an inverter 48, and also is caused to regenerate an electric power that is supplied to the battery 46 via the inverter 48 so that the battery 46 is charged with the regenerated electric power. Hereinafter, the first and second electric motors M1, M2 will be referred simply to as “electric motors M1, M2” where they are not particularly distinguished from each other. Each of hydraulic brakes 64 is configured to brake a corresponding one of the drive wheels 33 by a hydraulic pressure supplied from a hydraulic brake controller 62. A shift device 82 establishes a shift range based on an electric signal (hereinafter referred to as “shift position signal”) Psh or a P switch signal Pon, wherein the shift position signal Psh is a signal supplied from a shift sensor 58 that indicates a shift position selected by operation of a shift lever (not shown), and the P switch signal Pon is a signal selected by operation of a P switch 56. A hydraulic control unit 80 controls a gear position, by controlling hydraulic actuators of clutches C and brakes B of the automatic transmission portion 22, as described below.

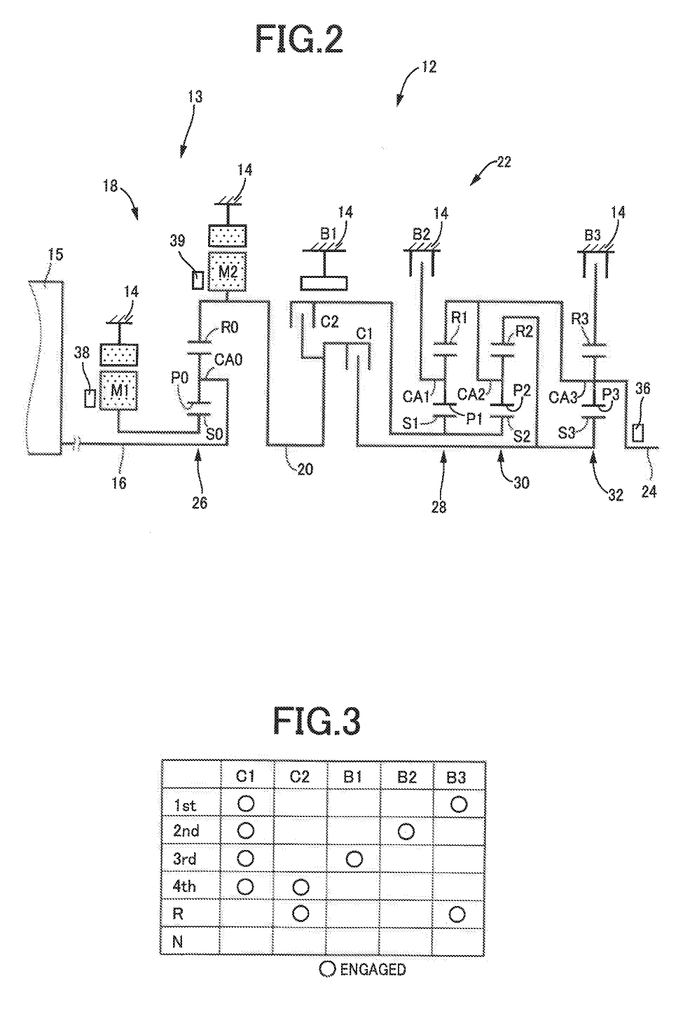

FIG. 2 is a view schematically showing construction of a power transmission device 12 constituting a part of a drive system that is installed on the vehicle 10. As shown in FIG. 2, the power transmission device 12 includes: a non-rotatable member in the form of a transmission casing 14 that is attached to a body of the vehicle 10; an input rotary member in the form of an input shaft 16; a continuously-variable transmission portion in the form of the differential portion 13 that is connected to the input shaft 16 directly or indirectly via a pulsation absorbing damper (not shown) or the like; an automatic transmission portion 22 that is connected to the differential portion 13 in a series through a transmitting member (transmitting shaft) 20 in a power transmitting path between the differential portion 13 and the pair of drive wheels 33; and an output rotary member in the form of an output shaft 24 that is connected to the automatic transmission portion 22. The input shaft 16, differential portion 13, automatic transmission portion 22 and output shaft 24 are disposed on a common axis within the transmission casing 14, and are connected in a series. The power transmission device 12 is suitably used in the vehicle 10 of an FR type (front-engine rear-drive type) in which an axis of the engine 15 is parallel to a longitudinal direction of the vehicle 10. The vehicle 10 is equipped with the engine 15 and the differential portion 13. The engine 15 as the drive power source for driving the vehicle 10 is connected to the input shaft 16 directly or indirectly through a pulsation absorbing damper (not shown) and is an internal combustion engine such as a gasoline engine or a diesel engine. The differential portion 13 as the continuously-variable transmission portion constitutes a part of the power transmission device 12, and also cooperates with the engine 15 to constitute the drive power source. The drive force of each of the engine 1.5 and the differential portion 13 is transmitted to the right and left drive wheels 33 sequentially via elements such as the automatic transmission portion 22 of the power transmission device 12, the differential gear device 17 and the pair of axels 25.

The differential portion 13 is a mechanical mechanism that mechanically distributes an output of the engine 15 that is inputted to the input shaft 16, and includes a power distributing mechanism 18 as a differential mechanism that distributes the output of the engine 15 to the first electric motor M1 and the transmitting member 20, the first electric motor M1 that is connected to the power distributing mechanism 18 in a power transmittable manner, and the second electric motor M2 that is operatively connected to the transmitting member 20 so as to be rotatable integrally with the transmitting member 20. In the present embodiment, each of the first and second electric motors M1, M2 is a so-called motor generator having also a power generation function. The second electric motor M2, which is connected to the drive wheels 33 in a power transmittable manner, has at least an electric motor function so as to function as a vehicle-driving electric motor as the drive power source for outputting the drive force.

The power distributing mechanism 18 is a differential mechanism connected between the engine 15 and the drive wheels 33, and is constituted principally by a differential-portion planetary gear unit 26 of single-pinion type. The differential-portion planetary gear set 26 includes rotary elements in the form of a differential-portion sun gear S0, differential-portion planetary gears P0, a differential-portion carrier CA0 that supports the differential-portion planetary gears P0 such that each of the planetary gears P0 is rotatable about its axis and revolvable about the above-described common axis, and a differential-portion ring gear R0 that meshes with the differential-portion sun gear S0 through the differential-portion planetary gears P0.

In the power distributing mechanism 18, the differential-portion carrier CA0 is connected to the engine 15 through the input shaft 16, the differential-portion sun gear S0 is connected to the first electric motor M1, and the differential-portion ring gear R0 is connected to the transmitting member 20. The power distributing mechanism 18 constructed as described above is placed in a differentially operable state (differential state) in which three elements of the planetary gear set 26 consisting of the differential-portion sun gear S0, differential-portion carrier CA0 and differential-portion ring gear R0 are rotatable relative to one another, thereby providing a differential effect. In the differential state, the output of the engine 15 is distributed to the first electric motor M1 and the power transmitting member 20, so that a part of the output of the engine 15 is used to drive the first electric motor M1 to generate an electric energy which is stored or used to drive the second electric motor M2. Namely, the differential portion 13 (power distributing mechanism 18) functions as an electric differential device, which is operable in a continuously-variable shifting state (electrically established CVT state) in which the rotational speed of the transmitting member 20 is continuously variable, irrespective of a certain rotational speed of the engine 15.

The automatic transmission portion 22 constitutes a part of a power transmitting path from the differential portion 13 to the output shaft 24, and includes first, second and third planetary gear sets 28, 30, 32 each of which is of single-pinion type. The automatic transmission portion 22 is a planetary-gear type multistage transmission that functions as a step-variable automatic transmission. The first planetary gear set 28 includes a first sun gear S1, first planetary gears P1, a first carrier CA1 supporting the first planetary gears P1 such that each of the first planetary gears P1 is rotatable about its axis and revolvable about the above-described common axis, and a first ring gear R1 meshing with the first sun gear S1 through the first planetary gears P1. The second planetary gear set 30 includes a second sun gear S2, second planetary gears P2, a second carrier CA2 supporting the second planetary gears P2 such that each of the second planetary gears P2 is rotatable about its axis and revolvable about the above-described common axis, and a second ring gear R2 meshing with the second sun gear S2 through the second planetary gears P2. The third planetary gear set 32 includes a third sun gear S3, third planetary gears P3, a third carrier CA3 supporting the third planetary gears P3 such that each of the third planetary gears P3 is rotatable about its axis and revolvable about the above-described common axis, and a third ring gear R3 meshing with the third sun gear S3 through the third planetary gears P3.

In the automatic transmission portion 22, the first and second sun gears S1, S2, which are integral with each other, are selectively connected to the transmitting member 20 through the second clutch C2, and selectively connected to the transmission casing 14 through the first brake B1. The first carrier CA1 is selectively connected to the transmission casing 14 through the second brake B2. The third ring gear R3 is selectively connected to the transmission casing 14 through the third brake B3. The first ring gear R1, the second carrier CA2 and the third carrier CA3, which are integral with one another, are connected to the output shaft 24. The second ring gear R2 and the third sun gear S3, which are integral with each other, are selectively connected to the transmitting member 20 through the first clutch C1.

In the automatic transmission portion 22, as shown in the table of FIG. 3, a selected one of gear positions is established by so-called “clutch-to-clutch” shifting operation with a releasing action of at least one releasing coupling device (that is to be released for establishing the selected gear position) and an engaging action of at least one engaging coupling device (that is to be engaged for establishing the selected gear position). It is noted that the gear positions have respective gear ratios rotational speed of the transmitting member 20/rotational speed of the output shaft 24) which change substantially in a geometric manner.

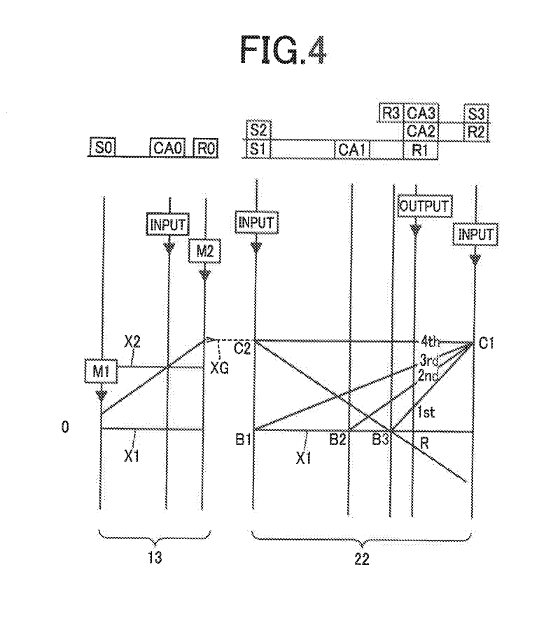

FIG. 4 is a collinear chart indicating a relationship among rotational speeds of rotary modules in each of the differential portion 13 and the automatic transmission portion 22 that cooperate to constitute the power transmission device 12, wherein the relationship among the rotational speeds of the rotary modules in each of the differential portion 13 and the automatic transmission portion 22 in each of the gear positions is represented by a straight line. The collinear chart of FIG. 4 is a two-dimensional coordinate system in which gear ratios of the respective planetary gear sets 26, 28, 30 and 32 are taken along the horizontal axis, while the relative rotational speeds of the rotary modules are taken along the vertical axis. A horizontal line X1 indicates a rotational speed of 0, a horizontal line X2 indicates a rotational speed Ne of the engine 15 connected to the input shaft 16, and a horizontal line XG indicates a rotational speed of the transmitting member 20.

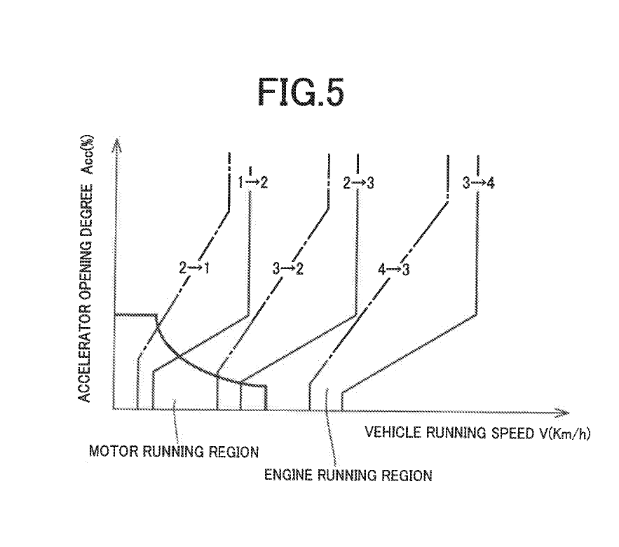

FIG. 5 shows a shifting map which is used for controlling gear shifting in the automatic transmission portion 22 and which represents shifting lines consisting of shift-up lines (indicated by solid lines) and shift-down lines (indicated by one-dot chain lines), which are stored in a memory means, such that the shifting lines are defined in a two-dimensional coordinate system having axes of variables in the form of a vehicle running speed V (km/h) and an accelerator opening degree Acc (%). It is determined whether a shifting action of the automatic transmission portion 22 should be performed, depending on a relationship between the shifting lines and a condition of the vehicle 10 represented by a combination of the actual vehicle running speed V (taken along the horizontal axis in FIG. 5) and the accelerator opening degree Acc (taken along the vertical axis in FIG. 5). FIG. 5 shows also a drive-power-source switching map used for switching between an engine running and a motor running. The motor running is selected to be performed in a region defined by thick solid line in which the vehicle running speed V and the accelerator opening degree Acc are small so that, in general, an engine efficiency is low.

In the vehicle 10, even in the engine running region, the electric power can be generated by the first electric motor M1 that is driven by the engine 15 and/or the drive power of the engine 15 can be assisted by the second electric motor M2 that is driven by the electric power supplied from the battery 46. Further, during a coast running as an inertia running after acceleration, when the second electric motor M2 is rotated by an inertia energy of the vehicle 10, the inertia energy is converted into an electric power with which the battery 46 is charged, namely, a regeneration can be made. Further, also during deceleration of the vehicle 10 with input of a brake operation signal Sb, the regeneration is made by the second electric motor M2.

Referring back to FIG, 1, the vehicle 10 is provided with an electronic control device 70 that controls parts relating to running of the vehicle 10. The electronic control device 70 includes, for example, a so-called microcomputer incorporating a CPU, a R0M, a RAM and an input-output interface. The CPU performs various control operations of the vehicle 10, by processing various input signals, according to control programs stored in the R0M, while utilizing a temporary data storage function of the RAM. The electronic control device 70 is constituted to include a plurality of control units for performing a hydraulic pressure control and a vehicle control such as a hybrid drive control relating to the engine 15, first electric motor M1 and second electric motor M2.

The electronic control device 70 receives various input signals such as: an output signal indicative of an engine rotational speed Ne (rpm) which is a rotational speed of the engine 15 and which is detected by an engine speed sensor 34; an output signal indicative of a vehicle running speed V (km/h) which corresponds to a rotational speed Nout (rpm) of the output shaft 24 that is detected by a vehicle speed sensor 36; a signal Nm1 indicative of a rotational speed (rpm) and a rotational direction of the first electric motor M1 which are detected y a rotational speed sensor such as a resolver 38; a signal. Nm2 indicative of a rotational speed (rpm) and a rotational direction of the second electric motor M2 which are detected y a rotational speed sensor such as a resolver 39; a received signal Sr such as big data and automatic driving command, which is received by a receiver 44; a transmitting signal St such as communication data that is to be transmitted from the vehicle 10 to other vehicles through a transmitter 45; a foot brake signal Brk indicative of operation of a brake pedal (not shown), which is detected by a foot brake switch 40; an output signal indicative of an accelerator opening degree Acc (%) that is detected by an accelerator sensor 42; an automatic-driving-mode selection signal Ad which indicates that an automatic driving mode is selected and which is supplied from an automatic-driving-mode selection switch 52 or transmitted through the receiver 44 from outside the vehicle 10; an auto-cruise setting signal Ac that indicates an auto cruise condition set by operation of an auto-cruise setting switch 54; the above-described P switch signal Pon that indicates that a parking position is selected by operation of the above-described P switch 56; the above-described shift position signal Psh that indicates an operating position of a shift lever (not shown), which is detected by the above-described shift sensor 58; an obstacle signal So that is supplied from an obstacle sensor 60 such as millimeter-wave radar and TV camera, which detects a front obstacle; and various signals that indicate a battery temperature Tb, a battery current Ib and a battery voltage Vb which are detected by a battery sensor 50.

The electronic control device 70 generates signals for controlling the engine 15 such as control signals Se for controlling an output of the engine 15, wherein the control signals Se includes an opening degree signal for controlling an electronic throttle valve of the engine 15, a boost-pressure regulating signal for regulating a boost pressure and an ignition signal for commanding the engine 15 to be ignited at desired timing. The electronic control device 70 further generates: a shift range signal Sp that indicates a shift range to be established by the shift device 82; a valve command signal Sv for activating solenoid valves that are included in the hydraulic control unit 80, so as to control hydraulic actuators (not shown) of the clutches C and the brakes B that are included in the automatic transmission portion 22; a signal Sc relating to acceleration, deceleration, steering and braking in automatic driving; a command signal Sm supplied to the inverter 48 so as to command activations of the electric motors M1, M2; and a hydraulic-brake control signal Sb supplied to the hydraulic brake controller 62 so as to control the hydraulic brakes 64.

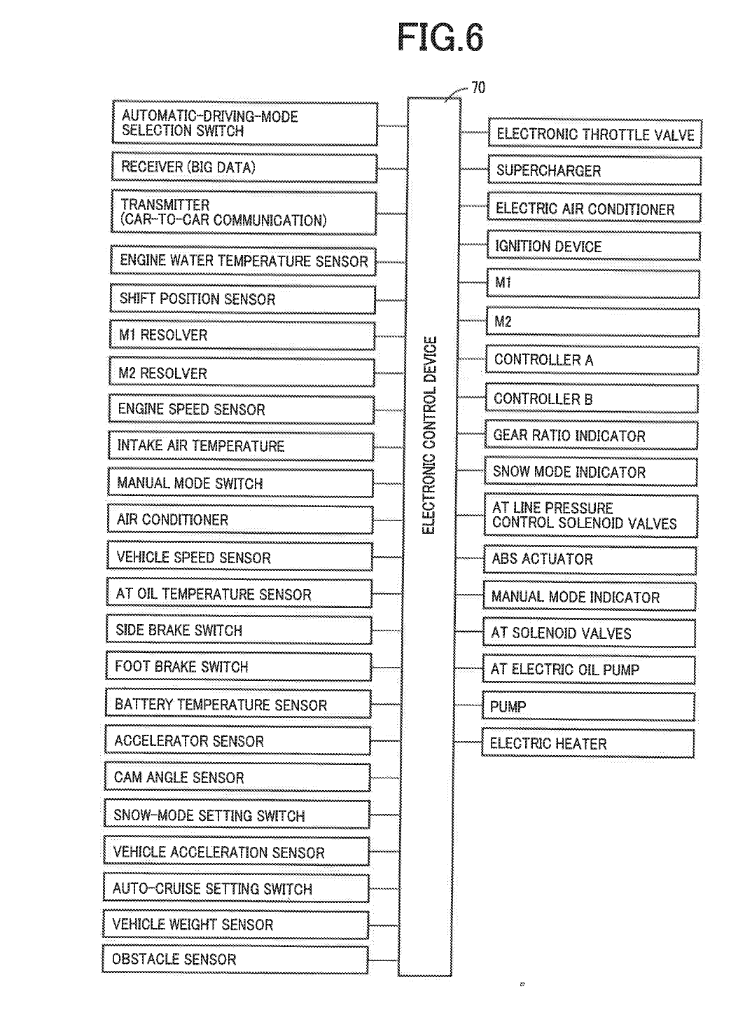

As shown in FIG. 6, the electronic control device 70 receives further various input signals such as: signals supplied from a supercharger, an electric air conditioner, various indicators, an electric oil pump and an electric heater. Further, the electronic control device 70 receives, from sensors and switches shown in FIG. 6, still further various input signals such as: a signal indicating an intake air temperature; a signal commanding a manual mode (manual-shift running mode); an air conditioner signal indicating activation of the air conditioner; a signal indicating operation of a side brake; a cam angle signal; a snow-mode setting signal indicating setting of a snow mode; an acceleration signal indicating a longitudinal acceleration of the vehicle; and a vehicle weight signal indicating a weight of the vehicle.

Referring back to FIG. 1, the electronic control device 70 is provided with functions for controlling regeneration by the electric motor M1 and/or the electric motor M2, when the vehicle 10 is automatically driven during manned running or unmanned running, and/or when the vehicle 10 is manually driven by operation of an occupant in the vehicle 10. The electronic control device 70 includes a driving-mode switching portion 100 that is surrounded by broken line. The driving-mode switching portion 100 includes an automatic driving controller 102, an auto cruise controller 104 and a manual driving controller 106. The electronic control device 70 further includes a unmanned-running determining portion 108, a regeneration preparing portion 110, a regenerative-torque calculating portion 112, a brake-condition setting portion 114 and a brake controlling portion 116. The unmanned-running determining portion 108 determines whether the vehicle 10 is in unmanned running or manned running. The regeneration preparing portion 110 includes a regeneration-range setting portion and an exterior-noise determining portion. The regeneration preparing portion 110 and the regenerative-torque calculating portion 112 are involved to control the regeneration. The brake-condition setting portion 114 and the brake controlling portion 116 cooperate to control a regenerative torque Tr and a hydraulic braking torque To that is generated by hydraulic brakes, when the vehicle 10 is to be braked.

The automatic driving controller 102 controls automatic driving of the vehicle 10 which is performed during either unmanned running without any occupant (such as a vehicle driver and a passenger) in the vehicle 10 or manned running with an occupant or occupant in the vehicle 10, and in which the vehicle 10 is automatically driven without operations (such as operations for accelerating, decelerating, steering and braking the vehicle 10) being made by an occupant of the vehicle 10. The auto cruise controller 104 has functions, which are performed during manual driving by a vehicle operator, such as a function of automatically driving the vehicle 10 at a constant running speed V and a function of automatically driving the vehicle 10 at a running speed V variable within a predetermined range while maintaining an appropriate distance to a vehicle preceding to the vehicle 10. The auto cruise controller 104 is configured, when the auto cruise is to be performed, to control acceleration, deceleration, steering and braking of the vehicle 10, in accordance with the auto cruise condition that is set by operation of the auto-cruise setting switch 54. The manual driving controller 106 is configured, when neither the automatic driving nor the auto cruise is performed, to control the vehicle 10, based on, for example, the accelerator opening degree signal Acc of the accelerator sensor 42, the foot brake signal Brk of the foot brake switch 40 and the shift position signal Psh of the shift sensor 58, which relate to manual operations made to an accelerator pedal, a brake pedal and a shift lever (not shown) of the vehicle 10.

When receiving the automatic-driving-mode selection signal Ad from the automatic-driving-mode selection switch 52 or from outside the vehicle 10 via the receiver 44, the electronic control device 70 selects an automatic driving mode in which the automatic driving is performed under control by the automatic driving controller 102, so that the automatic driving of the vehicle 10 starts. The unmanned-running determining portion 108 determines whether or not the vehicle 10 is in the unmanned running without any occupant therein. This determination is made, for example, depending on an output of a sensor (not shown) provided in each seat of the vehicle 10, a selection made on a panel (not shown) provided in the vehicle 10, or whether the vehicle 10 is remotely controlled in a remote control. The regeneration-range setting portion of the regeneration preparing portion 110 is configured to set a regeneration allowable range, namely, a range of an allowable regenerative torque Tp (i.e., allowable maximum regenerative torque Tp) that is allowed to be generated in each level of the running speed V upon regeneration by the electric motor M1 and/or the electric motor M2, such that the regeneration allowable range is set depending on, for example, whether there is a limitation on noise released outside the vehicle 10. The regenerative-torque calculating portion 112 calculates the allowable maximum regenerative torque Tp that is a maximum regenerative torque that is allowed to be generated at a certain value of the running speed V, such that the allowable maximum regenerative torque Tp is calculated based on the certain value of the running speed V. When receiving, for example, a braking command from the automatic driving controller 102, the brake-condition setting portion 114 sets the regenerative torque Tr that is not higher than the allowable maximum regenerative torque Tp (calculated by the regenerative-torque calculating portion 112) and also the hydraulic braking torque To that is to be generated by the hydraulic brakes 64. The brake controlling portion 116 receives a command from the brake-condition setting portion 114, and controls the regenerative torque Tr, i.e., a braking torque that is generated together with an electric energy which is generated by rotation of each of at least one of the electric motors M1, M2 and which is to be supplied to the battery 46 via the inverter 48, and also the hydraulic braking torque To of the hydraulic brakes 64 by controlling the hydraulic brake controller 62, such that the vehicle 10 is decelerated as desired. It is noted that the braking operation can be performed in any one of various manners, for example, such that the regenerative torque Tr may be a value that is close to the allowable maxinium regenerative torque Tp as much as possible, or such that a ratio between the regenerative torque Tr and the hydraulic braking torque To is set to a constant ratio such as 1:1 (50% 50%).

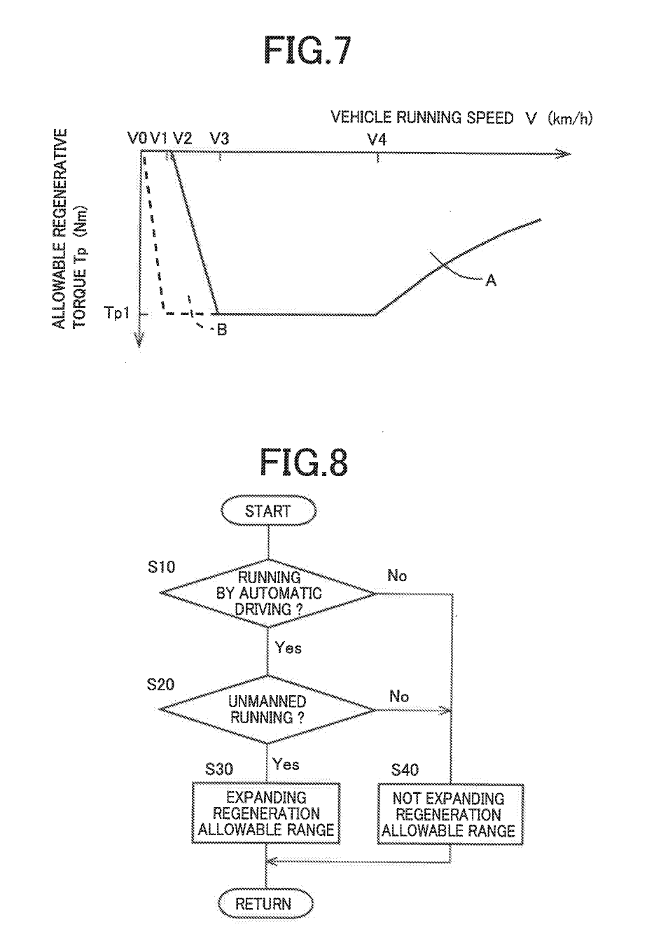

FIG. 7 shows the regeneration allowable range in a two-dimensional coordinate system in which the running speed V is taken along the horizontal axis while the regenerative torque Tr (allowable maximum regenerative torque Tp) is taken along the vertical axis. In this two-dimensional coordinate system, the running speed V is increased in rightward direction, while the regenerative torque Tr is increased in downward direction. A region A defined by solid line corresponds to the regeneration allowable range that varies depending on the running speed V. The allowable maximum regenerative torque Tp, which is represented by the sold line, is substantially zero when the running speed V is in a range from V0 (that is substantially zero) to V2, and is maximized to Tp1 as its largest value when the running speed V is in a range from V3 (first value) to V4 (second value). The allowable maximum regenerative torque Tp is reduced with increase of the running speed V when the running speed V is higher than V4. The allowable maximum regenerative torque Tp is set in the range of the running speed V not lower than V3, mainly for the purpose of restraining reduction of service lives of the second electric motor M2 and electric-accumulation-related components such as the battery 46 and the inverter 48, and is set in the range of the running speed V from V2 to V3, from a point of view of drivability, namely, mainly for the purpose of restraining vibration noise of the electric motors M1, M2 upon regeneration during deceleration of the vehicle 10, which gives discomfort to the occupant in the vehicle 10. A region B, which is defined by broken line and a part of solid line and in which the allowable maximum regenerative torque Tp is increased when the running speed V is in a range from V0, and reaches the largest value Tp1 when the running speed V is increased to V1 (first value), corresponds to an additional regeneration allowable range in which the regeneration is allowable in the unmanned running that does not require consideration of the drivability. In the unmanned running in which it is not necessary to take account of the drivability such as the vibration noise giving discomfort to the occupant, the regeneration allowable range can be increased by addition of the region B to the region A.

FIG. 8 is a flow chart showing a control routine executed for increasing or widening the regeneration allowable range, when the running speed V is low so as to he lower than V3 during unmanned running by automatic driving. This control routine, which is repeatedly executed, is initiated with step S10 in which it is determined that the vehicle 10 is running by automatic driving. When a negative determination is made at S10, the control flow goes to S40 that corresponds to functions of the regeneration-range setting portion of the regeneration preparing portion 110 and the regenerative-torque calculating portion 112. In this S40, the regeneration allowable range consisting of the region A shown in FIG. 7 is set as a normal range (i.e., non-expanded range), and the allowable maximum regenerative torque Tp is calculated based on the running speed V. When an affirmative determination is made at S10, S20 corresponding to function of the unmanned-running determining portion 108 is implemented to determine whether the vehicle 10 is in unmanned running or not. When a negative determination is made at S20, the control flow goes to S40 corresponding to functions of the regeneration-range setting portion of the regeneration preparing portion 110 and the regenerative-torque calculating portion 112, so that the regeneration allowable range consisting of the region A is set as the normal range, and the allowable maximum regenerative torque Tp is calculated based on the running speed V. When an affirmative determination is made at S20, namely, when it is determined that the vehicle 10 is in unmanned running, S30 corresponding to functions of the regeneration-range setting portion of the regeneration preparing portion 110 and the regenerative-torque calculating portion 112 is implemented to expand the regeneration allowable range. Namely, in this S30, an expanded range in the form of the regeneration allowable range consisting of the region A and the region B shown in FIG. 7 is set.

The electronic control device 70 according to the present embodiment is for the vehicle 10 which includes the electric motors M1, M2 that execute regeneration during deceleration of the vehicle 10 and which performs manned running with at least one occupant in the vehicle 10 and also unmanned running without any occupant in the vehicle 10. The control device 70 is configured to cause the electric motors M1, M2 to execute the regeneration within the regeneration allowable range, such that the regeneration allowable range (consisting of the regions A, B shown in FIG. 7) for the unmanned running is wider or larger than the regeneration allowable range (consisting of the region A shown in FIG. 7) for the manned running. Therefore, the fuel economy during the unmanned running can be improved as compared with that during the manned running. In other words, the electronic control device 70 makes it possible to improve the fuel economy during the unmanned running, as compared with a conventional control device. Further, the regeneration allowable range is defined by the allowable maximum regenerative torque Tp that is variable depending on the running speed V upon the regeneration. This arrangement makes it possible to improve the fuel economy by the regeneration during the unmanned running, and also to suitably restrain deterioration of components involved in execution of the regeneration.

It is noted that, in the above first embodiment, the normal range (i.e., the regeneration allowable range consisting of the regions A, B shown in FIG. 7) is selected not only when the vehicle 10 is in manned running by automatic driving but also when the vehicle 10 is running by either manual driving or auto cruise driving, both of which are performed necessarily in manned running rather than in unmanned running.

There will be described another embodiment of this invention. The same reference signs as used in the above-described first embodiment will be used in the following embodiment, to identify the functionally corresponding elements, and descriptions thereof are not provided.

### Second Embodiment

This second embodiment is different form the first embodiment in that, when noise of at least one of the electric motors M1, M2 released outside the vehicle 10 upon regeneration meets a predetermined noise condition, the regeneration allowable range (i.e., expanded range) for unmanned running by automatic driving is reduced to he close to the regeneration allowable range (i.e., non-expanded range) for manned running. However, the second embodiment is substantially the same as the above-described first embodiment in terms of other aspects.

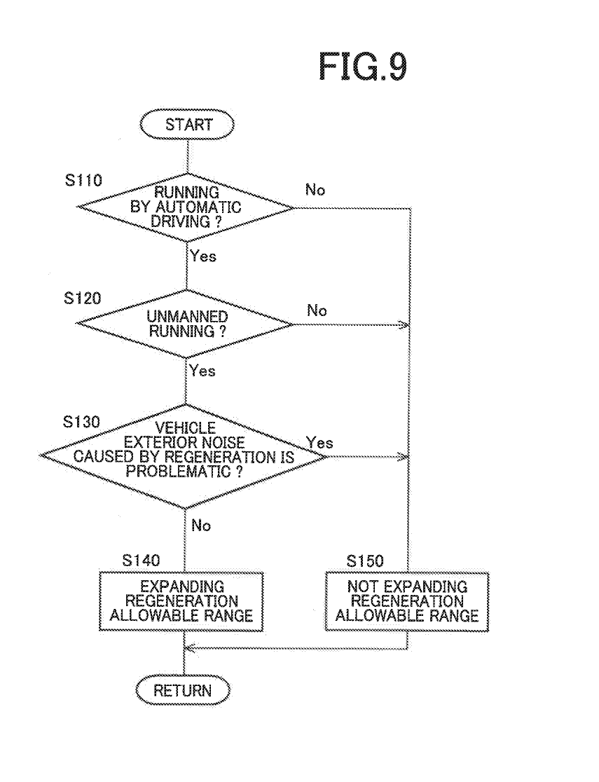

FIG. 9 is a flow chart showing a control routine including an additional step which is not included in the control routine of FIG. 8, and which is added so as to cope with a vehicle exterior noise that is caused by regeneration noise when the vehicle exterior noise is problematic. Whether the vehicle exterior noise is problematic or not, is determined based on whether the vehicle 10 runs in predetermined at least one area such as residential area and/or whether the vehicle 10 runs in predetermined at least one time period such as nighttime, wherein each of the predetermined at one area and the predetermined at least one time period may be deter based on a past complaint history collected from, for example, big data. The control routine of FIG. 9, which is repeatedly executed, is initiated with step S110 in which it is determined that the vehicle 10 is running by automatic driving. When a negative determination is made at S110, the control flow goes to S150 that corresponds to functions of the regeneration-range setting portion of the regeneration preparing portion 110 and the regenerative-torque calculating portion 112. In this S150, the regeneration allowable range consisting of the region A shown in FIG. 7 is set as a normal range (i.e., non-expanded range), and the allowable maximum regenerative torque Tp is calculated based on the running speed V. When an affirmative determination is made at S110, S120 corresponding to function of the unmanned-running determining portion 108 is implemented to determine whether the vehicle 10 is in unmanned running or not. When a negative determination is made at S120, the control flow goes to S150 corresponding to functions of the regeneration-range setting portion of the regeneration preparing portion 110 and the regenerative-torque calculating portion 112, so that the regeneration allowable range consisting of the region A is set as the normal range, and the allowable maximum regenerative torque Tp is calculated based on the running speed V. When an affirmative determination is made at S120, S130 corresponding to function of the exterior-noise determining portion of the regeneration preparing portion 110 is implemented to determine whether the vehicle exterior noise that is caused by regeneration by the electric motor M1 and/or the electric motor M2 is problematic or not, namely, to determine whether the vehicle exterior noise meets a predetermined noise condition that is determined based on the above-described at least one area and/or the above-described at least one time period, which may be determined based on the past complaint history collected from, for example, the big data. When an affirmative determination is made at S130, the control flow goes to S150 corresponding to functions of the regeneration-range setting portion of the regeneration preparing portion 110 and the regenerative-torque calculating portion 112, so that the regeneration allowable range consisting of the region A is set as the normal range, and the allowable maximum regenerative torque Tp is calculated based on the running speed V. When a negative determination is made at S130, S140 corresponding to functions of the regeneration-range setting portion of the regeneration preparing portion 110 and the regenerative-torque calculating portion 112 is implemented to expand the regeneration allowable range. Namely, in this S140, an expanded range in the form of the regeneration allowable range consisting of the region A and the region B is set, so that the regeneration allowable range is made wider, by addition of the region B as a low running speed region, than the regeneration allowable range consisting of only the region A. As described above, when it is determined at 130 that the vehicle exterior noise meets the predetermined noise condition, namely, the vehicle exterior noise is problematic, the control flow goes to S150 in which the regeneration allowable range consisting of the region A is set as the normal range. However, the control routine may be modified such that, when it is determined that the vehicle exterior noise is problematic, the regeneration allowable range may be set to consist of not only the region A but also an additional region which is a low running speed region like the region B and which is different from the region B in that it varies depending on whether the vehicle 10 runs in the above-described predetermined at least one area and/or whether the vehicle 10 runs in the above-described at least one time period. In this modified control routine, the regeneration allowable range in case when the vehicle exterior noise is determined to be problematic can be made somewhat larger than in the control routine shown in FIG. 9.

The electronic control device 70 according to this second embodiment is configured, when noise of the electric motor M1 and/or electric motor M2 released outside the vehicle 10 upon the regeneration meets the predetermined noise condition, to reduce the regeneration allowable range for the unmanned running, such that the regeneration allowable range for the unmanned running is reduced to be close to the regeneration allowable range for the manned running. This arrangement makes it possible to improve the fuel economy by the regeneration during the unmanned running, and also to restrain the noise generated upon the regeneration, from being released outside the vehicle 10 during the unmanned running, when the noise meets the predetermined noise condition, namely, when there is a high need to restrain the noise. Further, the predetermined noise condition includes running of the vehicle 10 in at least one area (such as residential area) and/or running of the vehicle 10 in at least one time period (such as nighttime), which are determined, for example, based on the history of complaints against the noise, such that the electronic control device 70 determines that the noise released outside the vehicle 10 upon the regeneration meets the predetermined noise condition, when the vehicle runs in the above-described at least one area and/or when the vehicle runs in the above-described at least one time period. This arrangement makes it possible to improve the fuel economy by the regeneration during the unmanned running, and also to more effectively restrain the noise generated by the electric motor upon the regeneration, from being released outside the vehicle during the unmanned running, by restraining the noise when the noise meets the predetermined noise condition which appropriately defines a situation or situations where there is a high need to restrain the noise.

There will be described still another embodiment of this invention. The same reference signs as used in the above-described embodiments will be used in the following embodiment, to identify the functionally corresponding elements, and descriptions thereof are not provided.

### Third Embodiment

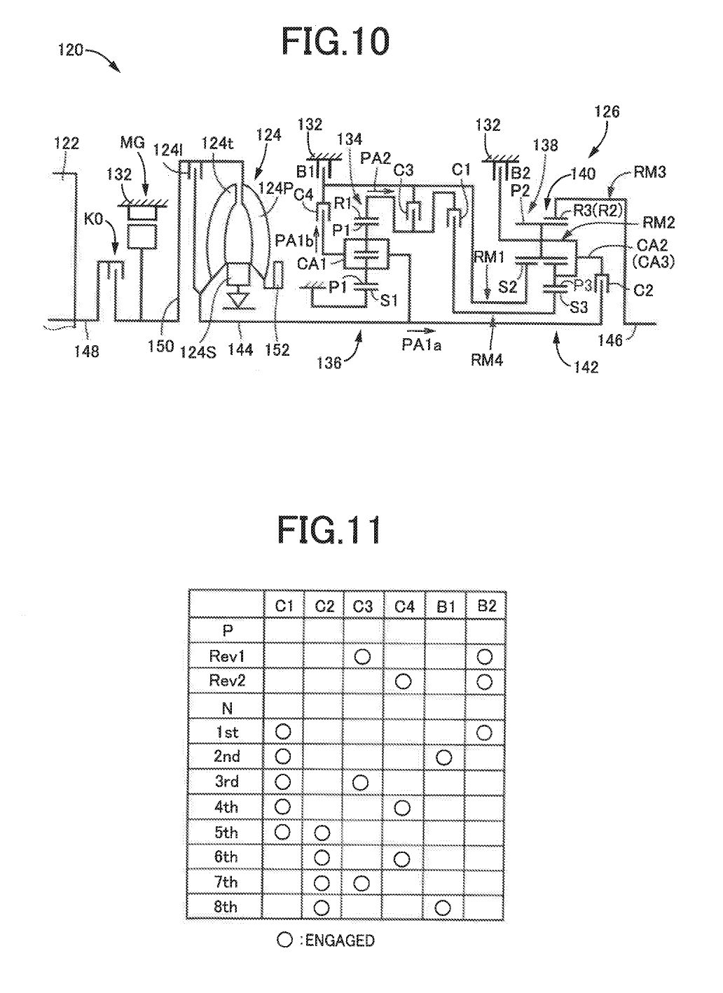

FIG. 10 is a view schematically showing constructions of a power transmission device 120 that is employed in place of the above-described power transmission device 12. In this power transmission device 120, too, as in the above-described first and second embodiments, the vehicle 10 includes an electric motor MG that executes regeneration during deceleration of the vehicle 10, and performs manned running with at least one occupant in the vehicle 10 and also unmanned running without any occupant in the vehicle 10, wherein the electronic control device 70 is configured to cause the electric motor MG to execute the regeneration within the regeneration allowable range, such that the regeneration allowable range is larger when the regeneration is executed by the electric motor MG during the unmanned running, than when the regeneration is executed by the electric motor MG during the manned running. Further, when noise of the electric motor MG released outside the vehicle 10 upon regeneration meets the predetermined noise condition, the regeneration allowable range (i.e., expanded range) for unmanned running by automatic driving is reduced to be close to the regeneration allowable range (i.e., non-expanded range) for manned running. Thus, in this third embodiment, substantially the same effects as in the above-described first or second embodiment can be obtained. In this third embodiment, the electronic control device 70 is substantially the same as in the above-described first and second embodiments, in terms of the functions of the driving-mode switching portion 100, unmanned-running determining portion 108, regeneration preparing portion 110, regenerative-torque calculating portion 112, brake-condition setting portion 114 and brake controlling portion 116, Which are shown in FIG. 1 but not shown in FIGS. 10 and 11 that are exclusively for this third embodiment. It is noted that the power transmission device 120 is constructed to be symmetrical with respect to its center line (its axis), and its lower half located on lower side of the axis is not shown in the schematic view of FIG. 10. As shown in FIG. 10, in this third embodiment, the power transmission device 120 includes: an engine 122; the above-described electric motor MG, a clutch K0 which is disposed in a power transmitting path between the engine 122 and the electric motor MG and which is to be selectively placed in its engaged, released or slipping state for controlling a power transmission in the power transmitting path; a torque converter 124 having an input shaft connected to the clutch K0; and an automatic transmission 126 disposed in a power transmitting path between the torque converter 124 and the differential gear device 17 (drive Wheels 33). In this third embodiment, the clutch K0, torque converter 124 and automatic transmission 1.26 cooperate to correspond to the power transmission device.

The clutch K0 is, for example, a multiple-disc, hydraulically-operated frictional coupling device. With the clutch K0 being placed in its engaged state, a crankshaft 148 of the engine 122 and a front cover 150 of the torque converter 124 are connected through the clutch K0, so that a power transmission therebetween is made. With the clutch K0 being placed in its released state, the crankshaft 148 of the engine 122 and the front cover 150 of the torque converter 124 are disconnected from each other, so that the power transmission therebetween is interrupted.

The torque converter 124 is a fluid power transmission device for performing a power transmission through a fluid, and includes a pump impeller 124p connected to the crankshaft 148 of the engine 122, a turbine impeller 124t connected to the automatic transmission 126 through a turbine shaft that corresponds to an output member of the torque converter 124, and a stator impeller 124s disposed between the pump impeller 124p and the turbine impeller 124t. Between the pump impeller 124p and the turbine impeller 124t, a lockup clutch 124l is disposed, so that the pump impeller 124p and the turbine impeller 124t are rotatable integrally with each other when the lockup clutch 124l is engaged. The pump impeller 124p is connected to a mechanical hydraulic pump 152 that is, for example, a vane pump, so that the hydraulic pump 152 is driven by rotation of the pump impeller 124p, for generating a hydraulic pressure that serves as an original pressure applied to a hydraulic control unit (not shown) or the like.

The automatic transmission 126 includes: a non-rotatable member in the form of a transmission casing 132 that is attached to a body of the vehicle 10; and first and second transmission portions 136, 138 which are provided inside the casing 132 and which are disposed on a common axis that is common to the first and second transmission portions 136, 142, wherein the first transmission portion 136 is constituted mainly by a first planetary gear set 134 of double-pinion type, and the second transmission portion 142 is constituted mainly by a second planetary gear set 138 of single-pinion type and a third planetary gear set 140 of double-pinion type. The automatic transmission 126 further includes an input shaft 144 and an output shaft 146, such that a rotary motion of the input shaft 144 is transmitted to the output shaft 146, at a gear ratio established in the automatic transmission 126. In this third embodiment, the input shaft 144 corresponds to the turbine shaft of the torque converter 124.

The first planetary gear set 134 includes a sun gear S1, a plurality of pairs of mutually meshing pinion gears P1, a carrier CA1 that supports the pinion gears P1 such that each of the pinion gears P1 is rotatable about its axis and revolvable about the above-described common axis, and a ring gear R1 that meshes with the sun gear S1 through the pinion gears P1. In the first planetary gear set 134, the sun gear S1, the carrier CA1 and the ring gear R1 constitute three rotary elements. The carrier CA1 is connected to the input shaft 144 so as to be driven to be rotated, while the sun gear S1 is integrally fixed to the casing 132 so as to be unrotatable. The ring gear R1 functions as an intermediate output member, and is to be rotated at a speed lower than the input shaft 144 so as to transmit the rotary motion to the second transmission portion 142. The rotary motion of the input shaft 144 is transmittable to the second transmission portion 142 through two different intermediate output paths PA1, PA2 such that a speed of the rotary motion as transmitted through the second intermediate output path PA2 is lower than a speed of the rotary motion as transmitted through the first intermediate output path PA1. The rotary motion of the input shaft 144 is transmitted to the second transmission portion 142 through the first intermediate output path PA1, without the speed of the rotary motion being changed, namely, with a predetermined gear ratio (=1.0). The first intermediate output path PA1 includes a direct transmitting portion PA1a and an indirect transmitting portion PA1b. The direct transmitting portion PA1a transmits the rotary motion of the input shaft 144 directly to the second transmission portion 142 without via the first planetary gear set 134. The indirect transmitting portion PA1b transmits the rotary motion of the input shaft 144 to the second transmission portion 142 via the carrier CA1 of the first planetary gear set 124. Meanwhile, the rotary motion of the input shaft 144 is transmitted to the second transmission portion 142 through the second intermediate output path PA2 (which is partially constituted by the carrier CA1, the pinion gears P1 supported by the carrier CA1 and the ring gear R1), with the speed of the rotary motion being changed (reduced), namely, with a gear ratio (>1.0) that is larger than the above-described gear ratio in the first intermediate output path PA1.

The second planetary gear set 138 includes a sun gear 52, pinion gears P2, a carrier CA2 that supports the pinion gears P2 such that each of the pinion gears P2 is rotatable about its axis and revolvable about the above-described common axis, and a ring gear R2 that meshes with the sur gear S2 through the pinion gears P2. The third planetary gear set 140 includes a sun gear S3, a plurality of pairs of mutually meshing pinion gears P2, P3, a carrier CA3 that supports the pinion gears P2, P3 such that each of the pinion gears P2, P3 is rotatable about its axis and revolvable about the above-described common axis, and a ring gear R3 that meshes with the sun gear S3 through the pinion gears P2, P3. The second and third planetary gear sets 138, 140 are partially connected to each other, and cooperate with each other to constitute four rotary modules RM1-RM4. Specifically described, the first rotary module RM1 is constituted by the sun gear S2 of the second planetary gear set 138, the second rotary module RM2 is constituted by the carrier CA2 of the second planetary gear set 138 and the carrier CA3 of the third planetary gear set 140 that are integrally connected to each other, the third rotary module RM3 is constituted by the ring gear R2 of the second planetary gear set 138 and the ring gear R3 of the third planetary gear set 140 that are integrally connected to each other, and the fourth rotary module RM4 is constituted by the sun gear S3 of the third planetary gear set 140. The second and third planetary gear sets 138, 140 cooperate with each other to constitute Ravigneaux type planetary gear train in which the carries CA2, CA3 are constituted by a common member, the ring gears R2, R3 are constituted by a common member, and the pinion gears P2 of the second planetary gear set 138 serve also as second pinion gears of the third planetary gear set 140.

The first rotary module RM1 (sun gear S2) is connected through the first brake B1 to the above-described casing 132, so as to be made unrotatable, when the first brake B1 is placed in its engaged state. Further, the first rotary module RM1 is connected through the third clutch C3 to the second intermediate output path PA2, i.e., the intermediate output member in the form of the ring gear R1 of the first planetary gear set 134 when the third clutch C3 is placed in its engaged state, and is connected through the fourth clutch C4 to the indirect transmitting portion PA1b of the first intermediate output path PA1, i.e., the carrier CA1 of the first planetary gear set 134 when the fourth clutch CA4 is placed in its engaged state. The second rotary module RM2 (carriers CA2, CA3) is connected through the second brake B2 to the casing 132, so as to be made unrotatable, when the second brake B2 is placed in its engaged state. Further, the second rotary module RM2 is connected through the second clutch C2 to the input shaft 144, i.e., the direct transmitting portion PA1a of the first intermediate output path PA1, when the second clutch C2 is placed in its engaged state. The third rotary module RM3 (ring gears R2, R3) is integrally connected to the output shaft 146, so as to output the rotary motion. The fourth rotary module RM4 (sun gear S3) is connected through the first clutch C1 to the ring gear R1, when the first clutch C1 is placed in its engaged state.

FIG. 11 is a table indicating a relationship between gear positions of the automatic transmission 116 and combinations of hydraulic, coupling devices that are placed in engaged states to establish the respective gear positions. In the table of FIG. 11, “∘ (circle)” indicates the engaged state, and “(blank)” indicates the released state. In the automatic transmission 116, a selected one of a plurality of gear positions (including eight forward drive gear positions) having respective different gear ratios γ is established by placing corresponding ones of the first clutch C1, second clutch C2, third clutch C3, fourth clutch C4, first brake 131 and second brake B2 in their engaged states. The gear ratio γ of each of the gear positions is suitably determined depending on gear ratios of the respective first, second and third planetary gear sets 134, 138 and 140.

In this third embodiment, as in the above-described first and second embodiments, the electronic control device 70 is for the vehicle 10 which includes the electric motor MG that executes regeneration during deceleration of the vehicle 10 and which performs the manned running and also the unmanned running. The control device 70 is configured to cause the electric motor MG to execute the regeneration within the regeneration allowable range, such that the regeneration allowable range (consisting of the region A and the region 13 shown in FIG. 7) for the unmanned running is wider or larger than the regeneration allowable range (consisting of the region A shown in FIG. 7) for the manned running. Therefore, the fuel economy during the unmanned running can be improved as compared with that during the manned running in other words, the electronic control device 70 makes it possible to improve the fuel economy during the unmanned running, as compared with a conventional control device. Further, when noise of the electric motor MG released outside the vehicle 10 upon the regeneration meets the predetermined noise condition, the regeneration allowable range for the unmanned running is reduced to be close to the regeneration allowable range for the manned running. This arrangement makes it possible to improve the fuel economy by the regeneration during the unmanned running, and also to restrain the noise generated upon the regeneration, from being released outside the vehicle 10 during the unmanned running, when the noise meets the predetermined noise condition, namely, when there is a high need to restrain the noise. Further, the predetermined noise condition includes running of the vehicle 10 in at least one area (such as residential area) and/or running of the vehicle 10 in at least one time period (such as nighttime), which are determined, for example, based on the history of complaints against the noise, such that the electronic control device 70 determines that the noise released outside the vehicle 10 upon the regeneration meets the predetermined noise condition, when the vehicle runs in the above-described at least one area and/or when the vehicle runs in the above-described at least one time period. This arrangement makes it possible to improve the fuel economy by the regeneration during the unmanned running, and also to more effectively restrain the noise generated by the electric motor upon the regeneration, from being released outside the vehicle during the unmanned running, by restraining the noise when the noise meets the predetermined noise condition which appropriately defines a situation or situations where there is a high need to restrain the noise.

In the above-described first through third embodiments, not only in the running by the automatic driving but also in the running by either the manual driving or the auto cruise driving, the braking of the vehicle 10 can be made by cooperation of the regenerative brake and the hydraulic brake, so that, by execution of the regeneration within the regeneration allowable range, it is possible to improve the fuel economy and to restrain deterioration of the electric motors M1, M2, MG, inverter 48, battery 46 and other components involved to store the electric power.

In the first through third embodiments, the vehicle 10, in which the electronic control device 70 according to the invention is provided, has the engine 15 or engine 122 and the electric motors M1, M2 or motor MG as the drive power sources. However, the invention is applicable also to a vehicle that has only an electric motor or electric motors as the drive power source or sources.

It is to be understood that the embodiments described above are given for illustrative purpose only, and that the present invention may be embodied with various modifications and improvements which may occur to those skilled in the art.

### NOMENCLATURE OF ELEMENTS

10: Vehicle
70: Electronic control device (Control device)
M1, M2. MG: Electric motors
V: Running speed
Tp: Allowable maximum regenerative torque

What is claimed is:

1. A control device for a vehicle which includes an electric motor that executes regeneration during deceleration of the vehicle and which performs manned running with at least one occupant in the vehicle and also unmanned running without any occupant in the vehicle, wherein
said control device is configured to cause the electric motor to execute the regeneration within a regeneration allowable range, such that said regeneration allowable range for the unmanned running of the vehicle is larger than said regeneration allowable range for the manned running of the vehicle.

2. The control device according to claim 1, wherein p1 said control device is configured, when noise of the electric motor released outside the vehicle upon the regeneration meets a predetermined noise condition, to reduce said regeneration allowable range for the unmanned running, such that said regeneration allowable range tier the unmanned running is reduced to be close to said regeneration allowable range for the manned running,

3. The control device according to claim 2, wherein
said predetermined noise condition includes running of the vehicle in at least one area and/or running of the vehicle in at least one time period, such that said control device determines that the noise of the electric motor released outside the vehicle upon the regeneration meets said predetermined noise condition, when the vehicle runs in said at least one area and/or when the vehicle runs in said at least one time period.

4. The control device according to claim 1, wherein
said control device is configured to cause the electric motor to execute the regeneration within said regeneration allowable range that is defined by an allowable maximum regenerative torque that is variable depending on a running speed of the vehicle upon the regeneration by the electric motor.

5. The control device according to claim 3, wherein
said at least one area and said at least one time period are determined based on a history of complaints against the noise.

6. The control device according to claim 4, wherein
said allowable maximum regenerative torque is increased with increase of the running speed when the running speed is smaller than a given value.

7. The control device according to claim 6, wherein
said allowable maximum regenerative torque is reduced with increase of the running speed when the running speed is larger than a second value that is larger than said given value as a first value.

8. The control device according to claim 6, wherein
said regeneration allowable range for the unmanned running is larger than said regeneration allowable range for the manned running, such that that said allowable maximum regenerative torque at a certain value of the running speed during the unmanned running is larger than said allowable maximum regenerative torque at said certain value of the running speed during the manned running, and
said certain value is smaller than said given value.

9. The control device according to claim 1, wherein
said control device includes:
an unmanned-running determining portion configured to determine whether the vehicle is in the unmanned running or not; and
a regeneration-range setting portion configured to set said regeneration allowable range for the unmanned running when it is determined by said unmanned-running determining portion that the vehicle is in the unmanned running, and configured to set said regeneration allowable range for the manned running when it is determined by said unmanned-running determining portion that the vehicle is not in the unmanned running.
